(19) United States
(12) Patent Application Publication
(10) Pub. No.: US 2008/0194322 A1
(43) Pub. Date: Aug. 14, 2008

(54) GAMING MACHINE WITH GAME MODES SELECTABLE TO DIFFERENT RATIO FOR PROVIDING AN AWARD PATTERN BY WAY OF A BUTTON

(75) Inventor: Hiro SAKUMA, Tokyo (JP)

Correspondence Address: ARENT FOX LLP, 1050 CONNECTICUT AVENUE, N.W., SUITE 400, WASHINGTON, DC, 20036, US

(73) Assignee: Aruze Corp., Tokyo (JP)

(21) Appl. No.: 11/971,074

(22) Filed: Jan. 8, 2008

(30) Foreign Application Priority Data
Jan. 10, 2007 (JP) 2007-002554

(51) Int. Cl. A63F 13/00; A63F 9/24

(52) U.S. Cl. 463/29

(57) ABSTRACT

A gaming machine is provided, which includes a memory, a plurality of selection switches and a controller. The memory stores a game program that has a plurality of awards and a plurality of game modes differing in patterns of ratios for providing the plurality of awards. The selection switches are associated with one of the plurality of game modes, respectively. The controller is configured with logic to execute the game program in a game mode associated with a selection switch from which the controller has received a signal.

This application is based on and claims the benefit of priority from Japanese Patent Application No. 2007-002554, filed on 10 Jan. 2007, the content of which is incorporated herein by reference.

### BACKGROUND OF THE INVENTION

1. Field of the Invention

The present invention relates to a gaming machine which can select a game mode with a different ratio for providing an award by means of a button.

2. Related Art

A conventional gaming machine is configured to perform a lottery in every single game so that an award resulting from a card combination is paid out. In addition, the ratio for providing an award and the patterns thereof are uniformly set in each gaming machine in a game hall or are uniquely set in each gaming machine. Specifically, when the ratio for providing an award and the patterns thereof are uniquely set in each gaming machine, the ratio for providing an award and the patterns thereof need to be set in every gaming machine. U.S. Pat. No. 5,820,459 addresses the problem that various variations of ratios for providing an award are provided so that players can get opportunities to select a gaming machine to play, thereby further improving entertainment properties in the entire game hall, but more space is adversely needed to install those machines.

U.S. Pat. No. 5,820,459 discloses that each gaming machine is connected to a network so that a server resets each gaming machine in regards to the number of providing a bonus, scheduling payout, and the like.

### SUMMARY OF THE INVENTION

However, although U.S. Pat. No. 5,820,459 can control a bonus using the server, it cannot change the ratio for providing an award and the patterns thereof, which includes awards other than those of the bonus. Specifically, the ratio for providing awards other than those of the bonus and the patterns thereof are uniform, and there is no provision for a player's selection in a single gaming machine. Furthermore, when the ratio for providing an award and the patterns thereof are fixed in each gaming machine so as to increase variations of the patterns, space cannot be saved.

The present invention has an object of saving space by decreasing the number of gaming machines to be installed and providing a gaming machine which can provide novel entertainment properties enjoyed by a player selecting one of the game modes, each of which has different patterns of ratio for providing an award.

In an aspect of the present invention, a gaming machine is provided, which includes a memory, a plurality of selection switches and a controller. The memory stores a game program that has a plurality of awards and a plurality of game modes differing in patterns of ratios for providing the plurality of awards. The selection switches are associated with one of the plurality of game modes, respectively. The controller is configured with logic to execute the game program in a game mode associated with a selection switch from which the controller has received a signal.

Since the gaming machine described above allows a player to select a game mode from the plurality of game modes differing in the ratios for providing the awards, it is not necessary to install gaming machines that have different ratios from one another so as to provide the player the similar chance, which is provided by one gaming machine according to the present invention. In this way, it is possible to decrease space required for installing the gaming machines. In addition, the gaming machine according to the present invention allows the player to try different probabilities to win an award in selecting a game mode. This gives a new dimension to the game in terms of entertainment.

In another aspect of the present invention, a gaming machine is provided, which includes a memory, a plurality of selection switches, a display device and a controller. The memory stores a game program that has a plurality of awards and a plurality of game modes differing in patterns of ratios for providing the plurality of awards. The selection switches are associated with one of the plurality of game modes, respectively. The display device displays a plurality of symbols and an image of rendered effects associated with each of the plurality of game modes. The controller is configured with logic to: (a) cause the display device to display the plurality of symbols and an image of rendered effects associated with a selection switch from which the controller has received a signal; and (b) execute the game program in a game mode associated with the selection switch.

In still another aspect of the present invention, a gaming machine is provided, which includes a memory, a plurality of selection switches, a display device and a controller. The memory stores a game program that has a plurality of awards and a plurality of game modes differing in patterns of ratios for providing the plurality of awards. The selection switches are associated with one of the plurality of game modes, respectively. The display device displays a plurality of symbols and an image of rendered effects associated with each of the plurality of game modes. The controller is configured with logic to: (a) perform a round of game including a dynamical display to a stationary display of the plurality of symbols on the display device; (b) cause the display device to display the plurality of symbols and an image of rendered effects associated with a selection switch from which the controller has received a signal; (c) execute the game program in a game mode associated with the selection switch; and (d) receive a signal sent from one of the plurality of selection switches after the termination of a round of game.

In yet another aspect of the present invention, a gaming machine is provided, which includes a memory, a plurality of selection switches, a display device and a controller. The memory stores a game program that has a plurality of awards and a plurality of game modes differing in patterns of ratios for providing the plurality of awards. The selection switches associated with one of the plurality of game modes, respectively. The display device displays a plurality of symbols. The controller is configured with logic to: (a) cause the display device to display an image of the plurality of symbols that move from a first portion to a second portion on the display device, receiving a signal from a selection switch associated with one game mode; (b) cause the display device to display an image of the plurality of symbols that move from the second portion to the first portion on the display device, receiving a signal from a selection switch associated with another game mode; and (c) execute the game program in the game mode associated with the selection switch from which the controller has received the signal.

In a further aspect of the present invention, a gaming machine is provided, which includes a memory, a plurality of selection switches, a display device and a controller. The memory stores a game program that has a plurality of awards and a plurality of game modes differing in patterns of ratios for providing the plurality of awards. The selection switches are associated with one of the plurality of game modes, respectively. The display device displays a plurality of symbols. The controller is configured with logic to: (a) perform a round of game including a dynamical display to a stationary display of the plurality of symbols on the display device; (b) cause the display device to display an image of the plurality of symbols that move from a first portion to a second portion on the display device, receiving a signal from a selection switch associated with one game mode; (c) cause the display device to display an image of the plurality of symbols that move from the second portion to the first portion on the display device, receiving a signal from a selection switch associated with another game mode; (d) execute the game program in the game mode associated with the selection switch from which the controller has received the signal; and (e) receive a signal sent from one of the plurality of selection switches after the termination of a round of game.

In a still further aspect of the present invention, a gaming machine is provided, which includes a memory, a plurality of selection switches, a display device and a controller. The memory stores a game program that has a plurality of awards and a plurality of game modes differing in patterns of ratios for providing the plurality of awards. The selection switches are associated with one of the plurality of game modes, respectively. The display device displays a plurality of symbols and an image of rendered effects associated with each of the plurality of game modes. The controller is configured with logic to: (a) cause the display device to display an image of the plurality of symbols that move from a first portion to a second portion on the display device, receiving a signal from one selection switch; (b) cause the display device to display an image of the plurality of symbols that move from the second portion to the first portion on the display device, receiving a signal from another selection switch; (c) cause the display device to display an image of rendered effects associated with the selection switch from which the controller has received the signal; and (d) execute the game program in the game mode associated with the selection switch.

In a yet further aspect of the present invention, a gaming machine is provided, which includes a memory, a plurality of selection switches, a display device and a controller. The memory stores a game program that has a plurality of awards and a plurality of game modes differing in patterns of ratios for providing the plurality of awards. The selection switches are associated with one of the plurality of game modes, respectively. The display device displays a plurality of symbols and an image of rendered effects associated with each of the plurality of game modes. The controller is configured with logic to: (a) perform a round of game including a dynamical display to a stationary display of the plurality of symbols on the display device; (b) cause the display device to display an image of the plurality of symbols that move from a first portion to a second portion on the display device, receiving a signal from one selection switch; (c) cause the display device to display an image of the plurality of symbols that move from the second portion to the first portion on the display device, receiving a signal from another selection switch; (d) cause the display device to display an image of rendered effects associated with the selection switch from which the controller has received the signal; (e) execute the game program in the game mode associated with the selection switch; and (f) receive a signal sent from one of the plurality of selection switches after the termination of a round of game.

In another aspect of the present invention, a gaming machine is provided, which includes a memory, a plurality of selection switches, a display device and a controller. The memory stores a game program including a first game mode and a second game mode, the first game mode providing a higher ratio for a particular award than the remaining awards among a plurality of awards and the second game mode providing a higher ratio for the remaining awards than the particular award. The selection switches are associated with the first game mode and the second game mode, respectively. The display device displays a plurality of symbols and an image of rendered effects associated with each of the plurality of game modes. The controller configured with logic to: (a) perform a round of game including a dynamical display to a stationary display of the plurality of symbols on the display device; (b) cause the display device to display an image of the plurality of symbols that move from a first portion to a second portion on the display device, receiving a signal from one selection switch associated with the first game mode; (c) cause the display device to display an image of the plurality of symbols that move from the second portion to the first portion on the display device, receiving a signal from another selection switch associated with the second game mode; (d) execute the game program in the game mode associated with the selection switch from which the controller has received the signal; and (e) receive a signal sent from one of the plurality of selection switches after the termination of a round of game.

The present invention is able to save space by decreasing the number of gaming machines to be installed and provide a gaming machine which can provide novel entertainment properties enjoyed by a player selecting one of the game modes, each of which has different patterns of ratio for providing an award.

### BRIEF DESCRIPTION OF THE DRAWINGS

FIGS. 1A and 1B are diagrams each showing a probability lottery table according to the present invention;

FIG. 2 is an overall perspective diagram showing a gaming machine according to the present invention;

FIG. 3 is an enlarged front elevation view showing a display screen and a design formation area of the liquid crystal display according to the present invention;

FIG. 4 is a diagram showing an example of symbol arrangement in the video reels displayed on the display screen according to the present invention;

FIG. 5 is a diagram showing a mechanical constitution of the gaming machine according to the present invention;

FIG. 6 is a block diagram showing an electrical configuration of a display/input controller of a gaming machine according to the present invention;

FIG. 7 is a flow chart for controlling the gaming machine executed by the controller according to the present invention;

FIGS. 8A and 8B are diagrams showing examples of rendered images in each game mode according to the present invention;

FIG. 9 is a diagram showing a symbol arrangement table according to the present invention; and

FIG. 10 is a diagram showing a payout table according to the present invention.

### DETAILED DESCRIPTION OF THE INVENTION

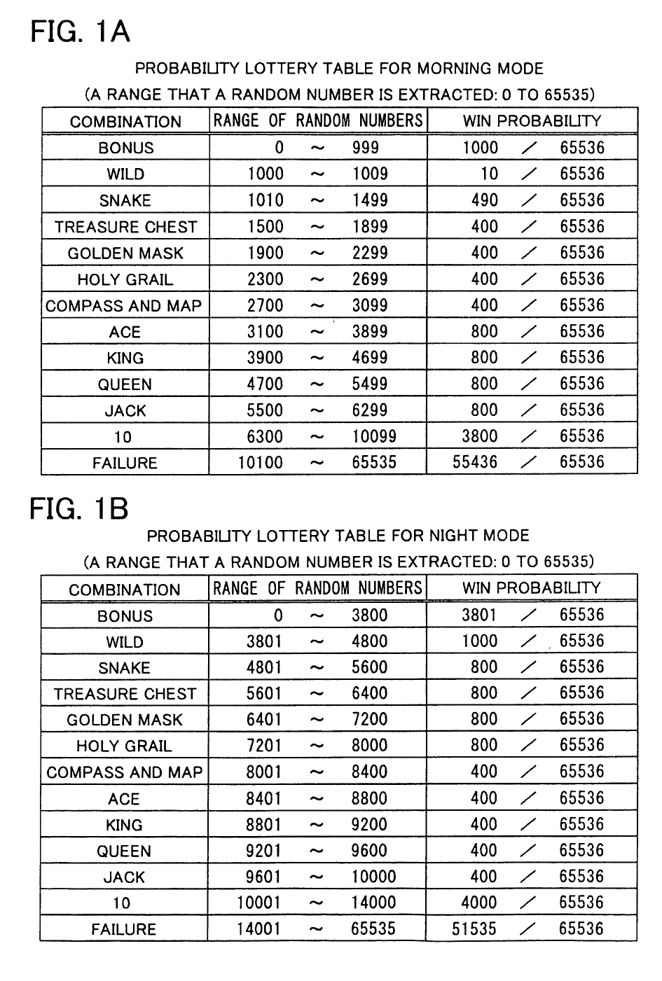

A gaming machine 1 according to the present invention accepts a selection of a game mode to perform a game program among a plurality of game modes for which patterns of ratio for providing an award are different. The gaming machine 1 which has accepted the selection reads a lottery table (FIG. 1A or 1B) corresponding to the game mode thus selected, and displays a rendered image corresponding to the game mode and video reels 3A to 3E on a liquid crystal display 30.

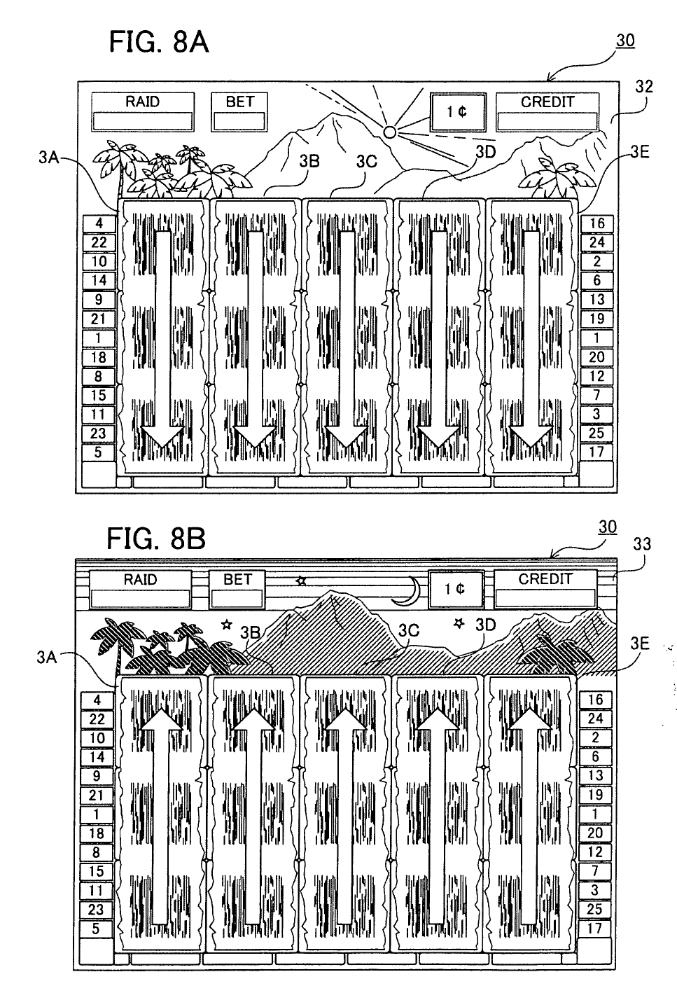

For example, when “Morning mode” is selected, a CPU 106 reads the “probability lottery table (FIG. 1A) for Morning mode” from ROM 108, and displays the corresponding rendered image data (for example, a rendered image 32 of FIG. 8A) on the liquid crystal display 30. Moreover, the video reels 3A to 3E are displayed on the liquid crystal display 30 in a way in which the video reels 3A to 3E move from top to bottom. In addition, when “Night mode” is selected, the CPU 106 reads the “probability lottery table (FIG. 1B) for Night mode” from the ROM 108, and displays the corresponding rendered image data (for example, a rendered image 33 of FIG. 8B) on the liquid crystal display 30. In addition, the video reels 3A to 3E are displayed on the liquid crystal display 30 in a way in which the video reels 3A to 3E moves from bottom to top.

a. Configuration of Gaming Machine

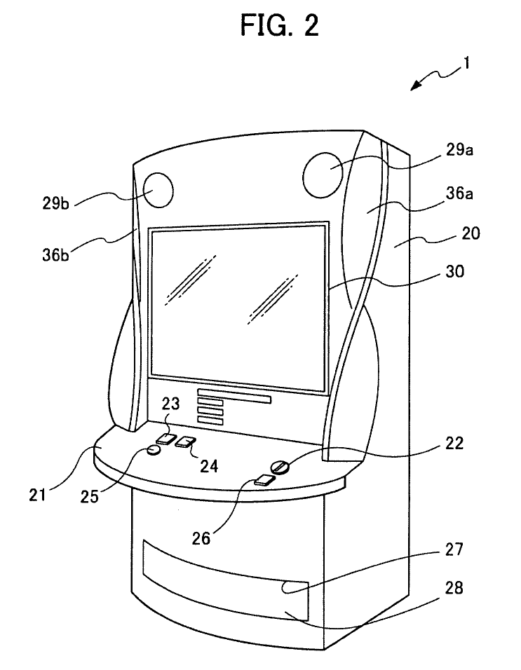

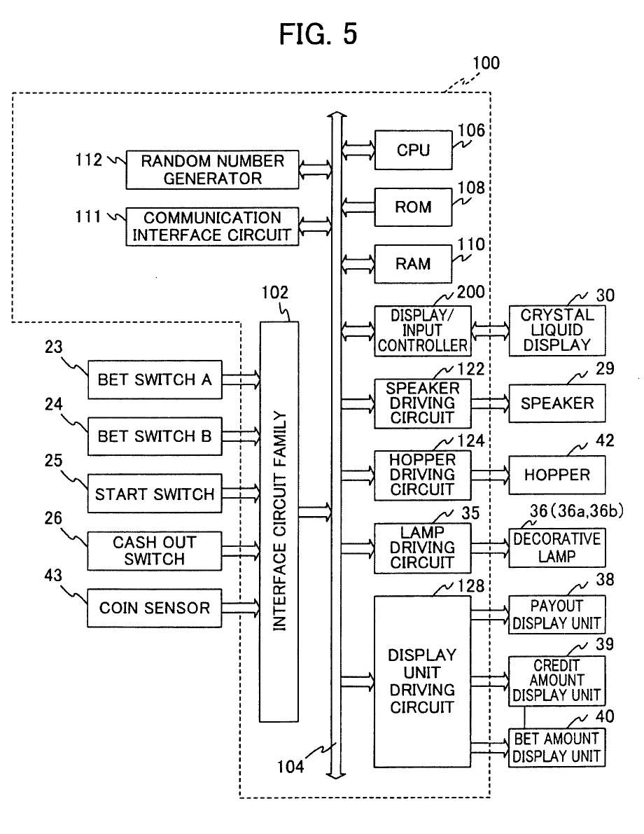

An overall configuration of the gaming machine 1 is explained below. FIG. 2 is an overall perspective view of the gaming machine 1. The gaming machine 1 is provided with a cabinet 20. The cabinet 20 includes various kinds of components. Such components include: a controller 100 (see FIG. 5) for electrically controlling the gaming machine 1; a hopper 42 for controlling insertion, retaining, and paying out of coins (game medium) (see FIG. 5), etc. Then, the liquid crystal display 30 is provided on a front surface of the cabinet 20.

The liquid crystal display 30 is provided for displaying various kinds of images with respect to the game including various kinds of rendered images, such as visual effects, and a plurality of symbols. Such a configuration allows the player to advance the game while visually confirming various kinds of images displayed on the liquid crystal display 30.

The slot machine 13 includes a substantially horizontal operation unit 21 below the liquid crystal display 30. This operating unit 21 is provided with a coin insertion opening 22, a bet switch A23, a bet switch B24, a start switch 25 and a cash out switch 26. The coin insertion opening 22 is disposed in the right side of the operating unit 21, which is an opening to insert a coin as a credit in the gaming machine 1.

The term “credit” refers to a game credit in the gaming machine. The credits may be currency circulated in the country where the present invention can be carried out. For example, the credits may also be medals that are uniquely used in the game hall where the present invention can be carried out and that are available to players by exchanging with currency in that country. In addition, the credit may be electromagnetic or electric information which can be stored in a storage medium such as a magnetic medium, an optical medium, and the like. In the case of electric information, the credits are stored in the storage medium as an award with values corresponding to the amount of the credits. In addition, “the credits” may be given to players by way of printed information such as a bar code, QR code and the like, as well as being stored in the storage medium. In the present embodiment described below, although the credits as so-called medals (coins) are paid out, it is selectable according to the way of payout employed in the gaming machine.

A bet switch A23 and a bet switch B24 are disposed in the left side of the operating unit 21 so as to determine which of winning lines (hereafter, “active pay lines”) L1, L2, L3, L4, L5, L6, L7, L8, and L9 described later are activated and to select the amount of credits as a gaming medium which are to be bet to a winning line thus activated. Furthermore, when the bet switch A23 or the bet switch B24 is pressed, the amount of credits to be bet to a combination which is expected to be achieved in a game is determined, and then a game mode with different patterns of ratio for providing an award is determined as described later.

In addition, a start switch 25 is disposed in the left side of the operating unit 21. More specifically, the start switch 25 is disposed in the left side of the bet switch A23 and the bet switch B24. The start switch 25 is a trigger for starting a game, which accepts the player's operations for starting the game in increments of games. When the start switch 25 is pressed, a CPU 106 described later reads a game program and a probability lottery table corresponding to a game mode from the ROM 108, thereby performing a game program in the selected game mode.

A cash out switch 26 is disposed in the vicinity of the coin insertion opening 22 so as to pay out the credits. Specifically, when a player presses the cash out switch 26, the credits which are inserted are paid out from coin payout opening 27 which is open on the lower front part of the gaming machine 1. The coins as the credits thus paid out are stored in a coin receiving pan 28.

Furthermore, sound transmission openings 29a and 29b are provided on both upper left and right sides of the liquid crystal display 30. Here, the sound transmission openings 29 are provided for transmitting sound effects generated by a speaker 29 (see FIG. 5) stored within the cabinet 20.

b. Constitution of the Display

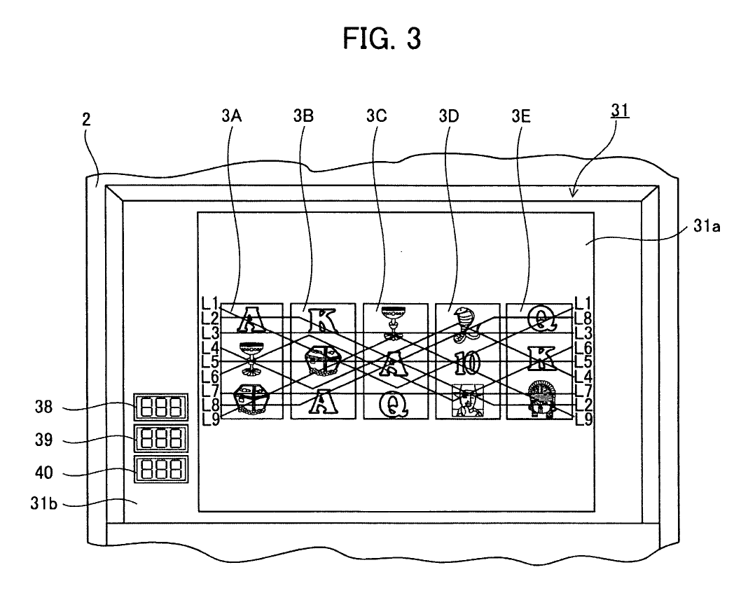

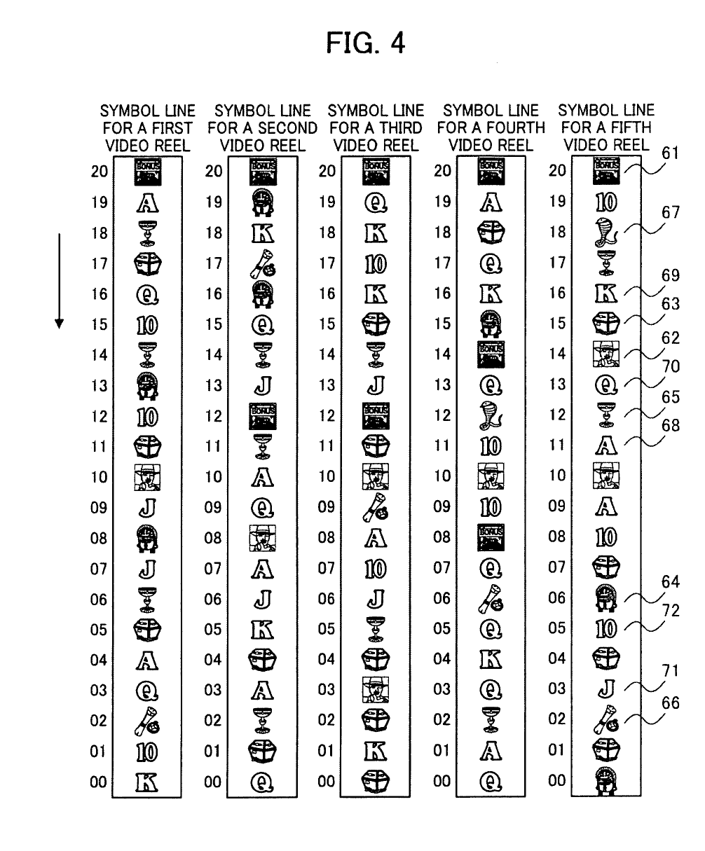

The liquid crystal display 30 in the gaming machine 1 is described according to FIGS. 3 and 4. FIG. 3 is an enlarged front elevation view showing a display screen 31a and a design formation area 31b of the liquid crystal display 30. FIG. 4 is a diagram showing an example of a symbol arrangement on video reels displayed on the display screen 31a.

As shown in FIG. 3, the liquid crystal display 30 includes a front panel 31 and the transparent liquid crystal panel (not shown) provided on the rear face of the front panel 31. The front panel 31 includes the display screen 31a and the design formation area 31b where designs have been formed. Such an arrangement allows the player to visually confirm the image information displayed on the front panel 31 provided on the rear face of the front panel 31 through the display screen 31a of the front panel 31.

A payout amount display portion 38, a credit amount display portion 39, and a bet amount display area 40 are provided in the left side of the display screen 31a on the liquid crystal display 30. These display units are disposed in the back side of the design formation area 31b of the front panel 31, in which parts covering the front of these display units are transparent. Consequently, players are able to visually confirm display contents on each display unit.

The payout amount display unit 38 displays the amount of credits paid out as an award upon achieving a winning combination. The credit amount display unit 39 displays the amount of coins retained in the gaming machine 13 in the form of credits. The bet amount display area 40 displays the amount of credits to be bet on a combination which is expected to be formed in a given game. Each of the display units 38 through 40 includes a seven segment display device. Alternatively, each of the display units 38 through 40 may be displayed on the liquid crystal panel 34 in the form of an image.

The present gaming machine 1 includes nine winning lines L1 to L9. Each of the winning lines L1 to L9 is formed such that it extends so as to pass through one of the symbols for each of the video reels 3A to 3E when the five video reels displayed on the liquid crystal display 30 have stopped.

Specifically, a first winning line L1 extends so as to pass through a symbol on an upper section of a first video reel 3A, a symbol on a middle section of a second video reel 3B, a symbol on a lower section of a third video reel 3C, a symbol on a middle section of a fourth video reel 3D, and a symbol on an upper section of a fifth video reel 3E.

A second winning line L2 extends so as to pass through symbols on upper sections of the first and second reels 3A and 3B, respectively, a symbol on a middle section of a third video reel 3C, and symbols on lower sections of the fourth and fifth video reels 3D and 3E, respectively.

A third winning line L3 extends straight in the horizontal direction so as to pass through the symbols on upper sections of all of the video reels 3A to 3E.

A fourth winning line L4 extends so as to pass through a symbol on a middle section of the first video reel 3A, a symbol on a lower section of the second video reel 3B, a symbol on a middle section of the third video reel 3C, a symbol on an upper section of the fourth video reel 3D, and a symbol on a middle section of the fifth video reel 3E.

A fifth winning line 5 extends straight in the horizontal direction so as to pass through the symbols on middle sections of all of the video reels 3A to 3E.

A sixth winning line L6 extends so as to pass through a symbol on a middle section of the first video 3A, a symbol on an upper section of the second video 3b, a symbol on a middle section of the third video 3C, a symbol on a lower section of the fourth video 3D, and a symbol on a middle section of the fifth video 3E.

A seventh winning line L7 extends straight in the horizontal direction so as to pass through the symbols on the lower sections of all of the video reels 3A to 3E.

An eighth winning line LB extends so as to pass through symbols on lower sections of the first and second reels 3A and 3B, respectively, a symbol on a middle section of a third video reel 3C, and symbols on upper sections of the fourth and fifth video reels 3D and 3E, respectively.

A ninth winning line L9 extends so as to pass through a symbol on a lower section of the first video 3A, a symbol on a middle section of the second video 3b, a symbol on an upper section of the third video 3C, a symbol on a middle section of the fourth video 3D, and a symbol on a lower section of the fifth video 3E.

Upon pushing the aforementioned bet switch 23 once, the third winning line L3, the fifth winning line L5, and the seventh winning line L7 are set to be active pay lines, and one coin is input as a credit medal, for example.

Furthermore, upon pushing the bet switch 23 twice, the first winning line L1, the fourth winning line L4, and the eighth winning line L8 are set to be active pay lines, in addition to the aforementioned three lines, and two coins are input as credit medals, for example.

Moreover, upon pushing the bet switch 23 three times, the second line L2, the sixth line L6, and the ninth line L9 are set to be active pay lines, in addition to the aforementioned six lines, and three coins are input as credit medals, for example.

FIG. 4 shows symbol lines on which 21 symbols arranged on each video reel 3A to 3E are represented. The symbol line for the first video reel corresponds to the video reel 3A. The symbol line for the second video reel corresponds to the video reel 3B. The symbol line for the third video reel corresponds to the video reel 3C. The symbol line for the fourth video reel corresponds to the video reel 3D. The symbol line for the fifth video reel corresponds to the video reel 3E. Referring to FIG. 4, a code number of “00” to “20” is assigned to each symbol of video reels 3A to 3E. The code number is converted to be data in a data table so as to be stored in ROM 108 described later (FIG. 5). On each video reel 3A to 3E, a symbol line is represented with symbols as follows: Bonus symbol (symbol 61) (hereafter, “Bonus”), Wild symbol (symbol 62) (hereafter, “Wild”), Treasure Chest symbol (symbol 63) (hereafter, “Treasure Chest”), Golden Mask symbol (symbol 64) (hereafter, “Golden Mask”), Holy Grail symbol (symbol 65) (hereafter, “Holy Grail”), Compass and Map symbol (symbol 66) (hereafter, “Compasses and Map”), Snake symbol (symbol 67) (hereafter, “Snake”), Ace symbol (symbol 68) (hereafter, “Ace”), King symbol (symbol 69) (hereafter, “King”), Queen symbol (symbol 70) (hereafter, “Queen”), Jack symbol (symbol 71) (hereafter, “Jack”), and 10 symbol (symbol 72) (hereafter, “10”). The symbol line of each video reel 3A to 3E is displayed in the way that it moves to the forward or backward directions in FIG. 4 (moving below from the top or up from the bottom) by moving the each video reel 3A to 3E in forward or backward directions.

Here in the present embodiment, each combination of “Bonus”, “Wild”, “Snake”, “Treasure Chest”, “Golden Mask”, “Holy Grail”, “Compass and Map”, “Ace”, “King”, “Queen”, “Jack” and “10” is set as a winning combination. A combination (combination data) is control information which relates credits awarded to a player (the amount of payout of coins) to winning combinations, and which is used for stop control of each video reel 3A through 3E, change (shift) of a game state, awarding of credits, and the like.

c. Mechanical Constitution of a Gaming Machine

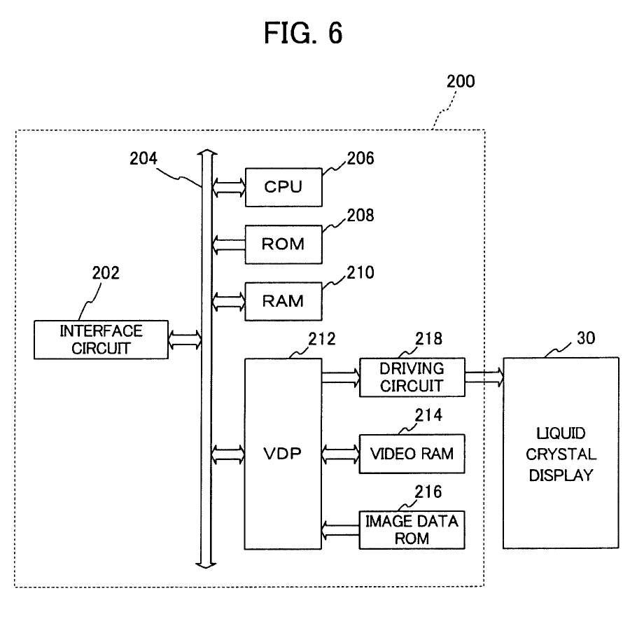

A mechanical constitution of the gaming machine 1 is described below. FIG. 5 is a diagram showing a mechanical constitution of the gaming machine 1. FIG. 6 is a diagram showing a constitution of a display/input controller of the gaming machine 1.

Components of the gaming machine 1 are described according to FIG. 5. The gaming machine 1 includes a controller 100, a liquid crystal display 30, a hopper 42, a bet switch A23, a bet switch B24, a start switch 25, a cash out switch 26, a coin sensor 43, a payout amount display unit 38, a credit amount display unit 39, and a bet amount display unit 40.

The controller 100 is a micro computer, and includes an interface circuit group 102, an input/output bus 104, a CPU 106, ROM 108, RAM 110, a communication interface circuit 111, a random number generator 112, a speaker driving circuit 122, a hopper driving circuit 124, a display unit driving circuit 128, and a display/input controller 140.

The interface circuits 102 are electrically connected with the input/output bus 104, which carries out input and output of data signals or address signals for CPU 106.

The start switch 25 is electrically connected with the interface circuits 102. In the interface circuits 102, a start signal generated by the start switch 25 is converted into a predetermined form of signal to be supplied to the input/output bus 104.

Furthermore, the bet switch A23, the bet switch B24, and the cash out switch 26 are connected to the interface circuit group 102. Each of the switching signals output from these switches A23, B24, and 26 is also supplied to the interface circuit group 102, and is converted into a predetermined signal by the interface circuit group 102. The switching signals thus converted are supplied to the input/output bus 104.

A coin sensor 43 is also electrically connected with the interface circuits 102. The coin sensor 43 detects coins inserted into the coin insertion opening 22, and is disposed at an appropriate position relative to the coin insertion opening 22. The sensing signal output from the coin sensor 43 is also supplied to the interface circuit group 102, and is converted into a predetermined signal by the interface circuit group 102. The sensing signal thus converted is supplied to the input/output bus 104.

The ROM 108 and the RAM 110 are connected to the input/output bus 104.

When the start switch 25 accepts an instruction for starting a game, the CPU 106 reads a game program and executes the game.

Also, the CPU 106 reads the game program so as to perform a bonus game when a predetermined award in the game is ready to be provided.

The ROM 108 stores: a control program for central control of the gaming machine 1; a program for executing a routine shown in FIG. 1; initial data for executing the control program; and various data tables used for lotteries. Examples of the data tables include tables such as those shown in FIGS. 1, 9, and 10.

The RAM 110 temporarily stores flags, variables, etc., used for the aforementioned control program.

Furthermore, a communication interface circuit 111 is connected to the input/output bus 104. The communication interface circuit 111 is a circuit for communicating with a server, etc., via various kinds of communication networks including a public telephone line network, LAN, etc.

The random number generator 112 for generating a random number is connected to the input/output bus 104. The random number generator 112 generates random numbers in a predetermined range of “0” to “65535” (the sixteenth power of two minus one), for example. Alternatively, an arrangement may be made in which the CPU 106 generates a random number by computation.

The speaker drive circuit 122 for the speakers 29 is also electrically connected with the input/output bus 104. The CPU 106 reads the sound data stored in the ROM 108, and transmits the sound data thus read to the speaker driving circuit 122 via the input/output bus 104. In this way, the speakers 29 generate predetermined sound effects.

The hopper drive circuit 124 for driving the hopper 42 is also connected with the input/output bus 104. Upon reception of a cash out signal input from the cash out switch 26, the CPU 106 transmits a driving signal to the hopper driving circuit 124 via the input/output bus 104. Accordingly, the hopper 42 pays out credits such that the amount thereof is equivalent to the current amount of credits, which is stored in a predetermined memory area of the RAM 110.

The display/input controller 200 is connected to the input/output bus 104. The CPU 106 creates an image display command corresponding to the state and results of the game, and outputs the image display command thus created to the display/input controller 200 via the input/output bus 104. Upon reception of the image display command input from the CPU 106, the display/input controller 200 creates a driving signal for driving the liquid crystal display 30 according to the image display command thus input, and outputs the driving signal thus created to the liquid crystal display 30. As a result, a predetermined image is displayed on the transparent liquid crystal panel of the liquid crystal display 30.

Referring to FIG. 6, the aforementioned display/input controller 200 is a sub microcomputer controlling an input from an image display processing, and is provided with a input/output bus 204, CPU 206, ROM 208, RAM 210, VDP 212, a video RAM 214, an image data ROM 216, and a driving circuit 218.

The interface circuit 202 is connected to the input/output bus 204. The image display command output from the CPU 106 included in the aforementioned controller 100 is supplied to the input/output bus 204 via the interface circuit 202. The input/output bus 204 performs input/output of data signals or address signals to and from the CPU 206.

The ROM 208 and the RAM 210 are connected to the input/output bus 204. The ROM 208 stores a display control program for generating a driving signal, which is to be supplied to the liquid crystal display 30, according to an image display command received from the CPU 106 included in the aforementioned controller 100. On the other hand, the RAM 210 stores flags and variables used in the aforementioned display control program.

The VDP 212 is also connected to the input/output bus 204. The VDP 212 includes a so-called sprite circuit, a screen circuit, a palette circuit, etc., and can perform various kinds of processing for displaying images on the liquid crystal display 30. With such an arrangement, the components connected to the DVP 212 include: the video RAM 214 for storing image data according to the image display command received from the CPU 106 included in the aforementioned controller 100 and the image data ROM 216 for storing various kinds of image data including the aforementioned rendered image data for visual effects, etc. Furthermore, the driving circuit 218 outputting a driving signal for driving the liquid crystal display 30 is connected to the VDP 212.

The aforementioned CPU 206 instructs the video RAM 214 to store the image data which is to be displayed on the liquid crystal display 30 according to the image display command received from the CPU 106 included in the aforementioned controller 100 by reading the display control program stored in the ROM 208 and by executing the program thus read. Examples of the image display commands include various kinds of image display commands including the aforementioned image display commands for visual effects, etc.

The image data ROM 216 stores various kinds of image data including the aforementioned image data for visual effects, etc.

As is clear from the above descriptions, the main component recited in the scope of the claims of the present invention corresponds to the controller 100, which includes the ROM 108 storing a routine execution program, the CPU 106 performing various kinds of controls according to the program stored in the ROM 108, the RAM 110 serving as a working area of the CPU 106, and the display/input controller 200 for controlling driving of the liquid crystal display 30 in the present embodiment. In the case of narrow interpretation thereof, the CPU 206, the ROM 208, the RAM 210, the VDP 212, the video RAM 214, the image data ROM 216, and the driving circuit 218 as components of the display/input controller 200 are included.

d. Process Flow of a Gaming Machine

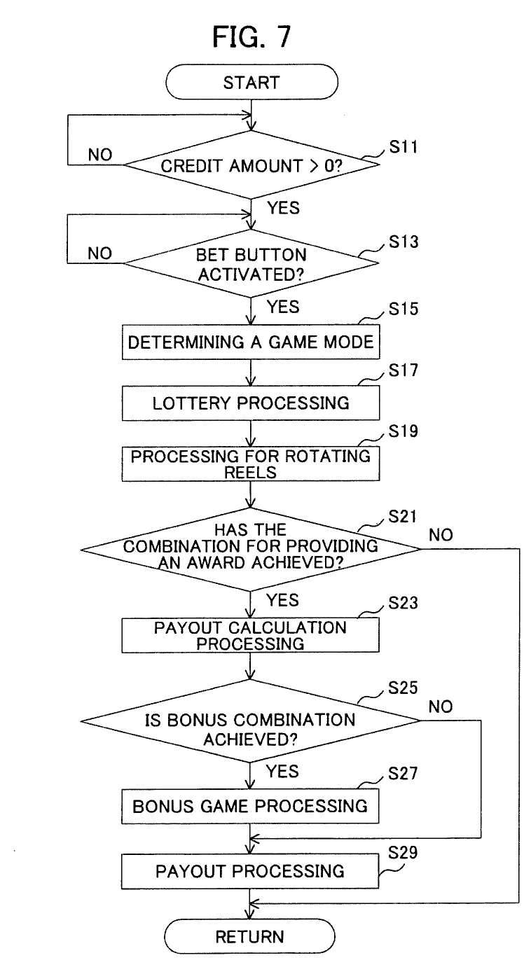

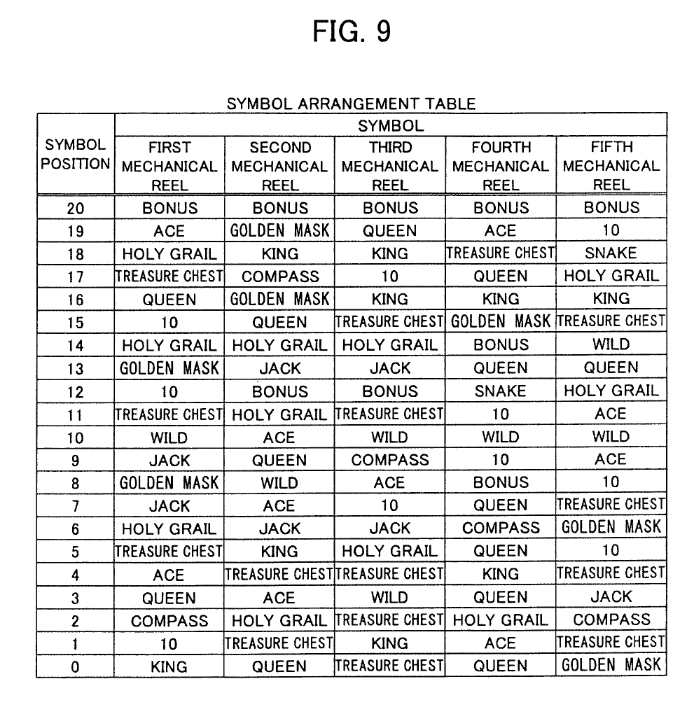

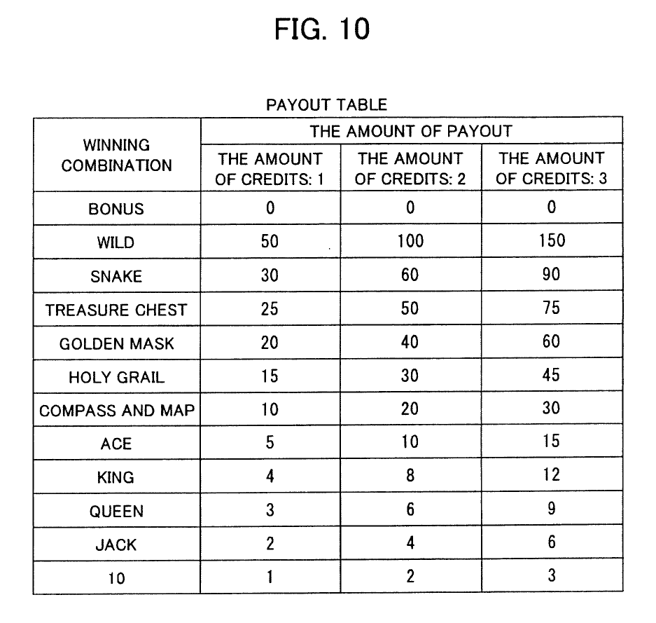

The process flow of the gaming machine 1 is described below. FIG. 7 is a flow chart for control of the gaming machine 1 executed by the controller 100. FIGS. 8A and 8B are diagrams showing examples of variably displaying rendered images and the video reels in each game mode. FIG. 9 is a diagram showing a symbol arrangement table. FIG. 10 is a diagram showing a payout table.

A series of the routine shown in FIG. 7 is called from a main program for the gaming machine 1 at a predetermined timing, and then is executed.

A description is provided below regarding a case in which the gaming machine 1 has been activated beforehand. Furthermore, the variables used by the CPU 106 included in the aforementioned controller 100 have been initialized to predetermined values, thereby operating the gaming machine 1 in a normal state.

First, the CPU 106 included in the aforementioned controller 100 determines whether or not any credits inserted by the player are remaining (Step S11). More specifically, CPU 106 reads the amount of credits C stored in the RAM 110, and executes processing according to the amount of credits C. When the amount of credits C equals “0” (NO in Step S11), the CPU 106 waits ready without executing any processing, since it cannot start a game. When the amount of credits C is not less than “1” (YES in Step S11), the CPU 106 determines that credits remain, and the CPU 106 moves the processing to Step S13.

In Step S13, the CPU 106 determines whether a pressing operation of the bet switch A23 or the bet switch B24 has been performed. When the CPU 106 receives an operational signal generated by the pressing operation of the bet switch A23 or the bet switch B24, the CPU 106 advances the processing to Step S15. In addition, the CPU 106 does not receive an operational signal generated by the pressing operation of the bet switch A23 or the bet switch B24 (NO in Step S13), the CPU 106 stands by without executing any processing.

When the CPU 106 receives a signal generated by the pressing operation of the bet switch A23 or the bet switch B24, the amount of credits to be bet on a winning line in the game is determined. Then, the CPU 106 stores the bet amount in relation to the winning line which is activated based on the number of operational signals thus received in a predetermined memory area of the RAM 110. The CPU 106 reads data for the amount of credits from the predetermined memory area of the RAM 110, and subtracts the total bet amount, which is the sum of the aforementioned bet amounts, from the amount of credits thus read. Then, the CPU 106 stores the subtracted amount of credits in the predetermined memory area of the RAM 110. In addition, in the present embodiment, only one of either the pressing operation on the bet switch A23 or on the bet switch B24 is accepted. For example, in a case where a player first presses the bet switch A23 to start betting, even if the player presses the bet switch B24 second, the CPU 106 does not accept an operational signal thereof. Although the bet amount on the winning line is determined by the number of times the bet switch A23 or the bet switch B24 (the number of operational signals which the CPU 106 receives) is pressed, a max bet switch A or a max bet switch B for example may be provided so as to bet the credits to all the winning lines by a single pressing operation to the switches.

In Step S15, the CPU 106 determines a game mode. More specifically, when the CPU 106 receives the operational signal by either one of the pressing operation to the bet switch A23 or the bet switch B24, the CPU 106 determines a game mode associated with the bet switch thus pressed. For example, in a case in which the bet switch A23 is associated with “Morning mode”, when the CPU 106 receives the operational signal generated by the bet switch A23, a game mode in a game program executed in subsequent games is rendered “Morning mode”.

More specifically, when the CPU 106 receives the operational signal from the bet switch A23 for example, the CPU 106 reads a probability lottery table for Morning mode corresponding to “Morning mode” from RAM 110. Simultaneously, the CPU 106 reads a rendered image corresponding to Morning mode from the image data ROM 216 in a display/input control 200 and displays it on the liquid crystal display 30. When this processing is terminated, the CPU 66 advances the process to Step S17.

Here, a game mode indicates that a game program is performed in the different patterns of ratio for providing an award. The patterns of ratio for providing an award include a pattern, for example, in which a predetermined number of winning combinations are set and the amount of credits to be distributed is different depending on each winning combination. The ratio for providing an award is low for a winning combination with a higher award while the ratio for providing an award is high for a winning combination with a lower award. On the contrary, the patterns of ratio for providing an award also include a pattern, for example, in which the ratio for providing an award is low for a winning combination with a lower award while the ratio for providing an award is high for a winning combination with a higher award. However, the present invention is not limited to the aforementioned examples.

Here, it is preferred that rendered images, video reels, and the like are displayed differently corresponding to a plurality of game modes. For example, in the case of a game mode in which the ratio for providing an award corresponding to the winning combination with the higher award is low while the ratio for providing an award corresponding to the winning combination with the lower award is high, the rendered image is displayed for “Morning mode”, which shows scenery in the morning on the liquid crystal display 30, and the direction of movement of video reels is from top to bottom in the image (FIG. 8A). In addition, in a case where the game mode in which the ratio for providing an award corresponding to the winning combination with the lower award is low while the ratio for providing an award corresponding to the winning combination with the higher award is high, the rendered image is displayed for “Night mode”, which shows scenery at night on the liquid crystal display 30, and the direction of movement of video reels is from bottom to top in the image (FIG. 8B).

Referring to FIG. 7 again, in Step S17, the CPU 106 performs lottery processing to determine a winning combination by an electronic lottery in the gaming machine 1. A detailed description is provided below regarding the lottery processing.

In the aforementioned lottery processing, the CPU 106 first determines the combination of the symbols when they are stationary along the aforementioned active pay line. Specifically, the CPU 106 issues a command for the random number generator 112 to generate a random number, thereby extracting a random number in a predetermined range (in a range of “0” to “65535” in the present embodiment) generated by the random number generator 112. The CPU 106 stores the random number thus extracted in a predetermined memory area of the RAM 110. It should be noted that a description is provided in the present embodiment regarding an arrangement in which the random number is generated by the random number generator 112, which is a separate component from the aforementioned CPU 106. Alternatively, an arrangement may be made in which the random number is generated by computational processing by the CPU 106 without involving the random number generator 112.

The CPU 106 reads a probability lottery table (see FIG. 1) and a combination table (not shown), each of which is stored in the ROM 108. Then, the CPU 106 stores the probability lottery table and the combination table thus read in a predetermined memory area of the RAM 110. In addition, the CPU 106 controls stopping operations in each video reel based on the aforementioned probability lottery table.

Furthermore, the CPU 106 reads the probability table and the combination table stored in the predetermined area of the aforementioned RAM 110. Then, the CPU 106 determines a combination of symbols to be stationary with respect to the aforementioned active pay lines with reference to the probability lottery table, using the random number values stored in the RAM 110 as a parameter. Upon determination of winning combinations, the CPU 106 stores the winning combination data thus determined in a predetermined memory area of the RAM 110.

Then, the CPU 106 reads the random number value and the winning combination data stored in the predetermined memory area of the RAM 110 and determines the combination of the symbols to be displayed to be stationary based upon the random number value and the winning combination data thus read. In this stage, a symbol arrangement table stored in the ROM 108 is read by the CPU 106. The symbol arrangement table thus read is stored in a predetermined memory area of the RAM 110, and used as reference data. The CPU 106 stores the data for the stationary symbols thus determined in a predetermined memory area of the RAM 110. Alternatively, an arrangement may be made in which the symbols to be stationary are determined for each reel using the aforementioned probability lottery table.

Here, the symbol arrangement table shown in FIG. 9 is explained. The symbol arrangement table relates the code number indicating the position of each symbol which constitutes the aforementioned symbol lines to each symbol of the respective video reels 3A to 3E, and then, registers thereof. In other words, the symbol arrangement table includes symbol information corresponding to the symbol position (the code number) of video reels 3A to 3E.

Also, the probability lottery table of FIG. 1 is explained. In the probability lottery table, a range of random numbers and the probability of winning are registered in association with each of the specified winning combinations. Also, a table depending on a provided game mode is provided. For example, in the presence of the game modes of “Morning mode” and “Night mode”, there are also the probability lottery tables for Morning mode (FIG. 1A) and the probability lottery table for Night mode (FIG. 1B) respectively. Regarding “Morning mode”, in lottery processing in Step S17, for example, in a case where a random number lying in a range of 0 to 999 is extracted from a range of numbers of 0 to 65535, the gaming machine 1 internally determines to generate a bonus combination. In other words, the probability is “1000/65536” that the combination of the stationary symbols matches any one of the bonus combinations. On the other hand, in a case where a random number lying in a range of 10100 to 65535 is extracted from a range of numbers of “0 to 65535”, the gaming machine 1 internally determines to generate other combinations, i.e. losing combinations. In other words, the probability is “55436/65536” that a combination of stationary symbols matches any one of the losing combinations.

Referring to FIG. 7 again, in the following Step S19, the CPU 106 instructs the video reels 3A through 3E to start a dynamical display. Specifically, the CPU 106 causes the video reels 3A to 3E to be dynamically displayed, in sequence or simultaneously, based upon the symbol arrangement table stored in the aforementioned RAM 110.

After a predetermined amount of time is elapsed since the video reels 3A to 3E have been dynamically displayed, the CPU 106 automatically instructs the video reels 3A to 3E to come to rest. Specifically, the CPU 106 causes the video reels 3A to 3E to come to rest sequentially or simultaneously such that the winning combinations determined in Step S15 or Step S17 are displayed within a display area, with which the player is visually interactive. Subsequently, the CPU 106 advances the processing to Step S21.

In Step S21, the CPU 106 determines whether the combination of the stationary symbols with respect to the active pay lines is any one of the winning combinations. In a case where the combination of the stationary symbols with respect to the active pay lines matches any one of the winning combinations, the CPU 106 activates a winning flag, which indicates a type of the winning combination, in order to provide an award that corresponds to the winning combination (Yes in Step S21). In addition, in a case where the award is “Bonus”, a bonus flag is also activated simultaneously. The CPU 106 stores the winning flag and the bonus flag, each of which has been activated, in a predetermined memory area in the RAM 110. Then, the CPU 106 advances the processing to Step S23. On the other hand, in a case in which the combination of stationary symbols with respect to winning lines matches any one of the losing combinations, the CPU 106 does not activate the winning flag (NO in the Step S21), and then terminates the present routine.

In Step S23, the CPU 106 executes payout calculation processing. More specifically, the CPU 106 reads the payout table in FIG. 10 that is stored in a predetermined area of the RAM 110, calculates the amount of credits corresponding to an award provided based on the winning combination determined in Step S21, and stores the amount of the credits thus determined in the predetermined memory area of the RAM 110. In addition, the CPU 106 may display the amount of credits awarded in a predetermined area on the liquid crystal display 30 simultaneously. When this processing is terminated, the CPU 106 advances the processing to step S25.

Here, the payout table shown in FIG. 12 is explained. In the payout table, the amount of credits to be paid out for each of amount of credits bet in a single game is registered in association with an award of each winning combination. Therefore, when the combination “Wild” has been occurred during a determination of the winning combination, the following cases may occur: If the amount of credits bet is “1”, 50 coins are paid out. If the credit amount bet is “2”, 100 coins are paid out If the credit amount bet is “3”, 150 coins are paid out.

Referring to FIG. 7 again, in Step S25, the CPU 106 determines whether the winning combination determined in Step S21 is a bonus combination. Specifically, the CPU 106 determines whether a bonus flag has been activated and stored in a predetermined area in the RAM 110. If the bonus flag has been activated (YES in Step S25), the CPU 106 advances the processing to Step S27. If the bonus flag has not been activated (NO in Step S25), the CPU 106 moves the processing to Step S29.

In Step S27, the CPU 106 performs bonus game processing. When the processing is terminated, the CPU 106 advances the processing to Step S29.

Although various bonus games are possible, a description is given of a case where a free game is a bonus game, for example. The free game indicates that a normal game is performed a predetermined number of times without betting coins as credits. In the bonus game processing, video reels 3A to 3E are repeatedly displayed to be scrolled and to be stationary a predetermined number of times. The award which has been achieved during the abovementioned processing is paid out to the player in Step S29 described later. In addition, although it is described that a condition for transition to the bonus game in the present embodiment is when a winning combination of “Bonus” in the probability lottery table is achieved, the present invention is not limited thereto, and may suddenly initiate the bonus game without any notice. For example, the bonus game may be initiated when a predetermined number of times, the game has been performed or when a predetermined amount of the credits bet in the gaming machine 1 continues to be stored in the RAM 110 and is thus accumulated enough to achieve a predetermined amount of credits. Other conditions can also be set. In addition, in the bonus game, a payout table with higher awards than a normal table may be used.

In Step S29, the CPU 106 performs payout processing. Specifically, the CPU 106 reads award data stored in a predetermined area in the RAM 110, and then pays out coins (credits) based on the award data. The coins as credits may be paid out to the coin payout opening 27 for payout. Alternatively, the CPU 106 may read the data of the amount of credits stored in a predetermined area in the RAM 110 so as to determine the sum of the amount of credits in the award data which are calculated in Step S25, thereby storing the summed value in a predetermined area in the RAM 100. Regarding a method of payout, any method employed in the gaming machine 1 can be used. In a case of adding up as the data of the amount of credits, it is preferable that the value thus stored is displayed on the credit amount display unit 39. The CPU 106 then ends the routine.

In addition, it is clear that the present invention is not limited to the abovementioned embodiments, and can be modified and improved variously without departing from the spirit of the present invention. For example, in the present embodiment, the direction of scrolling the video reels can be changed from top to bottom or bottom to top on the display, depending on game modes with the different patterns of ratio for providing an award. However, the present invention is not limited thereto. For example, the direction of scrolling the video reels may be changed on the display from the vertical direction to the horizontal direction, and moreover from right to left or left to right.

In addition, although in the present embodiment, so as to accept a player's selection the CPU 106 accepts an input signal generated by a pressing operation from the bet switch A or the bet switch B corresponding to each game mode, the present invention is not limited thereto. For example, the CPU 106 may accept selection by the player through receiving an input signal indicating a pressing operation of a start switch, to which the selection of a game mode is functionally assigned.

Furthermore, although in the present embodiment an example using video reels has been described, the video reels may be mechanical reels, and may be applied to a gaming machine which employs a transparent liquid crystal display on the front surface of the gaming machine 1. In a case of using mechanical reels, it is configured so that symbols on an outer surface of the video reels are arranged, and the video reels stop according to a lottery in the gaming machine 1. Then, an award is provided based on a combination of a plurality of symbols, each of which is stopped on a plurality of the mechanical reels. In addition, the transparent liquid crystal display is disposed on the top surface of the mechanical reels on the front surface of the gaming machine 1, through which the mechanical reels may be seen using visual effects or a rendered image may be displayed on the entire transparent liquid crystal display by rendering the transparent liquid crystal display opaque.

What is claimed is:

1. A gaming machine comprising:
a memory storing a game program that has a plurality of awards and a plurality of game modes differing in patterns of ratios for providing the plurality of awards;
a plurality of selection switches associated with one of the plurality of game modes, respectively; and
a controller configured with logic to:
(a) execute the game program in a game mode associated with a selection switch from which the controller has received a signal.

2. The gaming machine according to claim 1, further comprising:
a display device that displays a plurality of symbols and an image of rendered effects associated with each of the plurality of game modes;
wherein the controller is further configured with logic to:
(b) cause the display device to display the plurality of symbols and an image of rendered effects associated with the selection switch.

3. The gaming machine according to claim 2, wherein the controller is further configured with logic to:
(c) perform a round of game including a dynamical display to a stationary display of the plurality of symbols on the display device and
(d) receive a signal sent from one of the plurality of selection switches after the termination of a round of game.

4. A gaming machine comprising:
a memory storing a game program that has a plurality of awards and a plurality of game modes differing in patterns of ratios for providing the plurality of awards;
a plurality of selection switches associated with one of the plurality of game modes, respectively;
a display device for displaying a plurality of symbols; and
a controller configured with logic to:
(a) cause the display device to display an image of the plurality of symbols that move from a first portion to a second portion on the display device, receiving a signal from a selection switch associated with one game mode;
(b) cause the display device to display an image of the plurality of symbols that move from the second portion to the first portion on the display device, receiving a signal from a selection switch associated with another game mode; and
(c) execute the game program in the game mode associated with the selection switch from which the controller has received the signal.

5. The gaming machine according to claim 4, wherein the controller is further configured with logic to:
(d) perform a round of game including a dynamical display to a stationary display of the plurality of symbols on the display device and
(e) receive a signal sent from one of the plurality of selection switches after the termination of a round of game.

6. A gaming machine comprising:
a memory storing a game program that has a plurality of awards and a plurality of game modes differing in patterns of ratios for providing the plurality of awards;
a plurality of selection switches associated with one of the plurality of game modes, respectively; and
a display device that displays a plurality of symbols and an image of rendered effects associated with each of the plurality of game modes; and
a controller configured with logic to:
(a) cause the display device to display an image of the plurality of symbols that move from a first portion to a second portion on the display device, receiving a signal from one selection switch;
(b) cause the display device to display an image of the plurality of symbols that move from the second portion to the first portion on the display device, receiving a signal from another selection switch;
(c) cause the display device to display an image of rendered effects associated with the selection switch from which the controller has received the signal; and
(d) execute the game program in the game mode associated with the selection switch.

7. The gaming machine according to claim 6, wherein the controller is further configured with logic to:
(e) perform a round of game including a dynamical display to a stationary display of the plurality of symbols on the display device and
(f) receive a signal sent from one of the plurality of selection switches after the termination of a round of game.

8. A gaming machine comprising:
a memory storing a game program including a first game mode and a second game mode, the first game mode providing a higher ratio for a particular award than the remaining awards among a plurality of awards and the second game mode providing a higher ratio for the remaining awards than the particular award;
a plurality of selection switches associated with the first game mode and the second game mode, respectively; and
a display device that displays a plurality of symbols and an image of rendered effects associated with each of the plurality of game modes; and
a controller configured with logic to:
(a) perform a round of game including a dynamical display to a stationary display of the plurality of symbols on the display device;
(b) cause the display device to display an image of the plurality of symbols that move from a first portion to a second portion on the display device, receiving a signal from one selection switch associated with the first game mode;
(c) cause the display device to display an image of the plurality of symbols that move from the second portion to the first portion on the display device, receiving a signal from another selection switch associated with the second game mode;
(d) execute the game program in the game mode associated with the selection switch from which the controller has received the signal; and
(e) receive a signal sent from one of the plurality of selection switches after the termination of a round of game.
